(19) United States
(12) Patent Application Publication
(10) Pub. No.: US 2003/0194515 A1
(43) Pub. Date: Oct. 16, 2003

(54) POLYOLEFIN BASED HOT MELT ADHESIVE FOR PREAPPLIED HEAT SEAL APPLICATIONS

(76) Inventors: INGRID COLE, SOMERVILLE, NJ (US); CHARLES W. PAUL, MADISON, NJ (US); BRIAN MORRISON, LEBANON, NJ (US)

Correspondence Address: LYDIA T. MCNALLY, NATIONAL STARCH AND CHEMICAL COMPANY, BOX 6500, BRIDGEWATER, NJ, 088070500

(21) Appl. No.: 09/186,237

(22) Filed: Nov. 4, 1998

(51) Int. Cl. B32B 1/02

(52) U.S. Cl. 428/35.2

(57) ABSTRACT

A bag formed utilizing a hot melt adhesives comprising (a) 20 to 70 parts ethylene/alpha olefin polymer having a melt index of 50 to 500 MI, a melt point of 71 to 90° C., a density of 0.885 to 0.90, a composition distribution breadth index greater than 50%, and Mw/Mn less than 6; (b) 10 to 50 parts tackifier; and (c) 0 to 30 parts wax.

### BACKGROUND OF THE INVENTION

Hot melt adhesives, 100% solids materials, which are applied to a substrate when molten and cooled to harden the adhesive layer, are widely used for industrial applications.

Current technology relies on either polyethylene or ethylene vinyl acetate (“EVA”) based adhesives. EVA based adhesives offer good adhesion to difficult substrates such as fluorocarbon coated papers. The disadvantage of this type of adhesive is that it will retack at elevated temperatures.

Therefore, if used as a preapplied heat seal on bags, the bags can block together when stacked on a pallet. This type of blocking is predominately seen on bags with UV, waterborne and solvent borne coatings, and on Kraft bags.

Polyethylene based adhesives display excellent non-block properties however adhesion is sacrificed, and the reactivation temperature can be high, 220° to 260° F.

The current invention offers a balance of excellent adhesion, good non-block properties and a low reactivation temperature. It utilizes ethylene/alpha olefin based polymers with a low melt point and density to achieve these properties. The resultant formulas show better adhesion than an EVA based product without sacrificing non-block performance. The reactivation temperature is unexpectedly lower than both EVA and polyethylene based products.

### SUMMARY OF THE INVENTION

The present invention is directed to hot melt adhesives prepared from:

a) 20 to 70 parts ethylene/alpha olefin polymer having a melt index of 10 to 500 MI, a melt point of 71 to 90° C., a density of 0.885 to 0.92, a composition distribution breadth index greater than 50%, and Mw/Mn less than 6;

b) 10 to 50 parts tackifier; and

c) 0 to 30 parts wax.

The present invention is also directed to the use of these adhesives in pre-applied heat seal applications such as pinch bottom bag-ending.

### DETAILED DESCRIPTION OF THE INVENTION

The present invention is directed to hot melt adhesive compositions hot melt adhesives prepared from:

a) 20 to 70 parts ethylene/alpha olefin polymer;

b) 10 to 50 parts tackifier; and

c) 0 to 30 parts wax.

Ethylene/alpha olefin polymers useful herein are those having a melt index of 10 to 500 MI, a melt point of 71 to 90° C., a density of 0.885 to 0.92, a composition distribution breath index greater than 50%, and Mw/Mn less than 6. Preferably, the ethylene/alpha olefin polymers will have a melt index of 50 to 500 MI and a density of 0.885 to 0.90.

As used herein, composition distribution index, or short chain branching distribution index refers to the weight percent of polymer molecules having a comonomer content within 50% of the median total comonomer content.

Examples of ethylene/alpha olefin polymers useful herein include EXACT 4040, an ethylene/butene copolymer with 50 MI, density of 0.885, melt point 73° C.; and EXACT 4038, an ethylene/butene copolymer with 125 MI, density of 0.885, both available from Exxon.

Tackifiers useful in the present invention include aliphatic or cycloaliphatic hydrocarbons, aromatic hydrocarbons, aromatically modified aliphatic or cycloaliphatic hydrocarbons and mixtures thereof. EASTOTAC H130, a hydrogenated cyclopentadiene-based tackifier with a softening point of 130° C. is the most preferred tackifier.

Other tackifiers useful herein include polyterpenes, terpene phenolic, aromatic modified terpene, and combinations thereof. Also included are the hydrogenated derivatives of phenolic modified terpene resins, for example, as the resin product resulting from the condensation, in an acidic medium, of a bicyclic terpene and a phenol. An example of a commercially available phenolic modified terpene tackifier is NIREZ 7042 which has a Ring and Ball softening point of about 140° C. and is available from Arizona Chemical Company. An example of a commercially available styreneated polyterpene is ZONTAC 105L which has a Ring and Ball softening point of about 105° C. and is available from Arizona Chemical Company.

The preferred tackifiers of the present invention are those having a softening point of 90 to 150° C. The present invention contemplates that the adhesive composition of the present invention comprise one or more of the above adhesive promoting tackifying resins.

Waxes suitable for use in the present invention include the low melting point synthetic Fischer-Tropsch waxes or polyethylene type waxes characterized by a melting point of about 71 to 115° C. The most preferred wax is PARAFLINT H1001 a synthetic wax with melting point of 98° C. available from Sasol. Other preferred waxes include PARAFLINT H4, with a melting point of 94.5° C. also available from Sasol and MARCUS ONE, a 115° C. polyethylene wax available from Marcus. The wax component is utilized at levels of 0 to 30 parts based on the weight of the adhesive.

The adhesives of the present invention may also contain a stabilizer or antioxidant. Among the applicable stabilizers or antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the deprotonated hydroxyl group serves to retard its stretching frequency, and correspondingly, its reactivity; this hindrance thus providing the phenolic compound with its stabilizing properties. Representative hindered phenols include; 1,3,5-trimethyl-2,4,6-tris-(3, 5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis (2,6-tert-butyl-phenol); 4,4′-thiobis (6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; sorbitol hexa[3-(3,5-di-tert-butyl-4-hydroxy-phenyl)-propionate] and 2,6-ditertbutyl 4-methylphenol (“BHT”). An example of a commercially available antioxidant is IRGANOX 1010, a hindered phenol, available from Ciba Geigy.

The performance of these antioxidants may be further enhanced by utilizing, in conjunction therewith, known synergists such as, for example, thiodipropionate esters and phosphites. Distearylthiodipropionate is particularly useful. These stabilizers, if used, are generally present in amounts of about 0.1 to 1.5 weight percent, preferably 0.25 to 1.0 weight percent.

The present invention also contemplates the addition to the adhesive of a polymeric additive selected from the group consisting of ethylene methyl acrylate polymers containing 10 to 28 weight percent by weight methyl acrylate, ethylene acrylic acid copolymers having an acid number of 25 to 150, polyethylene, polypropylene, poly(butene-1-co-ethylene) polymers, ethylene n-butyl acrylate copolymers and ethylene vinyl acetate copolymers. When such additive is present, it is present in amounts up to about 15 weight percent by weight of composition.

Depending on the contemplated end uses of the adhesives, other additives such as plasticizers, pigments and dyestuffs conventionally added to hot melt adhesives may be included. In addition, small amounts of additional tackifiers and/or waxes such as microcrystalline waxes, hydrogenated castor oil, amide waxes and vinyl acetate modified synthetic waxes may also be incorporated in minor amounts, i.e., up to about 10 weight percent by weight, into the formulations of the present invention.

A preferred embodiment of the present invention is directed to a hot melt adhesive composition comprising:

a) 0.5% IRGANOX 1010;

b) 50% EXACT 4038, 125 melt index, 0.885 density, melt point 73° C.;

c) 20% MARCUS ONE, 115° C. polyethylene wax; and

d) 30% EASTOTAC H130, 130° C. partially hydrogenated cyclopentadiene.

The adhesive compositions of the present invention are prepared by blending the components in the melt at a temperature of about 177° C. until a homogeneous blend is obtained, approximately two hours. Various methods of blending are known in the art and any method that produces a homogeneous blend is satisfactory.

The resulting adhesives are characterized by a viscosity less than about 20,000 cps at 177° C. They may be applied at temperatures of 300 to 400° F. to provide superior adhesive bonds even when exposed to a wide variety of temperature conditions. The product possess a combination of good adhesion to fluorocarbon coated paper, good nonblock properties, and lower reactivation temperatures.

The hot melt adhesives of the present invention are particularly useful for use in pre-applied heat seal applications such as pinch bottom bag-ending.

The following examples are provided for illustrative purposes only, and are not intended to limited the scope of the present application in any way.

### EXAMPLES

In the following examples, the following procedures were used:

FX 845 and FC807 are fluorocarbon coated paper used in bags and as a grease proof coating. Adhesion to FC807 and FX 845 coated papers was measured by applying a bead of adhesive at 350° F., 0.12 in. uncompressed, to the fluorocarbon and mating to a clay coated side. Bonds are aged 24 hours at room temperature, 40° F., 20° F., and 0° F., and pulled by hand. Fiber tear, (%) is then accessed.

Block resistance was measured by preapplying 5 to 7 mil films of adhesive at 350° F. to Kraft UV coated bags. After 24 hours, these bags are cut to 2×2 inch squares and stacked on top of each other. Typically four sheets are stacked together in an oven at 170° F., with a 3.75 lb/in² force placed on the stack. After 24 hours, the weight is removed and blocking, ink lift, and fiber tear are accessed as the stacks are pulled apart.

Viscosity was measured by a Brookfield viscometer, using spindle #27.

Reactivation was measured by pre-applying 5 to 7 mil adhesive film to Kraft paper at 350° F. Using a heat sealer, a piece of uncoated Kraft and coated Kraft are resealed at 1 second of 15 psi pressure. The temperature is increased in 10° F. increments and bonds are pulled 20 minutes after reseal. The reactivation temperature is defined as temperature where 100% fiber tear is achieved.

### Example I

The following materials were used to prepare a series of hot melt adhesives in accordance with the present invention: ELVAX 420 is an ethylene vinyl acetate polymer comprising 18% vinyl acetate, and having a melt index 150. ELVAX 460 is an ethylene vinyl acetate polymer comprising 18% vinyl acetate, and having a melt index of 2. Both are available from E.I. duPont de Nemours and Co. The polyethylene polymer is AT 191A which has a density of 0.913 and a melt index of 160, available from AT Plastics. The tackifier is EASTOTAC H130 which is a hydrogenated cyclopentadiene-based tackifier with softening point of 130° C. and available from Eastman Chemical. NIREZ 2040HM is a terpene phenolic tackifier having a Ring and Ball softening point about 118° C. and available from Arizonia Chemical Company. The antioxidant chosen was IRGANOX 1010 which is available from Ciba-Geigy or LOWINOX BHT from Great Lakes. The synthetic wax either PARAFLINT H4 or PARAFLINT H1001 available from Moore and Munger.

The following ethylene/butene copolymers were used:

| | | |
|---|---|---|
| Copolymer A | density = 0.901 | melt index = 125 |
| Copolymer B | density = 0.885 | melt index = 125 |
| Copolymer C | density = 0.885 | melt index = 50 |

The physical properties discussed above were tested and the results, along with the adhesive formulation, are shown in Table I below.

Samples C1 and C2 are comparative samples. C1 is a typical ethylene vinyl acetate (“EVA”) based product; C2 is a typical polyethylene (“PE”) based product. Sample C2 shows relatively good non-block properties, but adhesion is poor. Sample C1 shows good non-block on Kraft, poor non-block on UV coated bags, and improved adhesion compared to the polyethylene sample, C2.

Samples 2-4 were prepared in accordance with the present invention. Samples 2, 3 and 4 show better non-block than the EVA sample, C1. Compared to the PE sample, C2, Samples 2 and 3 showed similar or better non-block properties.

With respect to adhesion, Samples 2, 3 and 4 showed better adhesion than the PE sample, and similar or better adhesion than the EVA sample.

Sample 1 was prepared by adding wax to the PE sample, C2. As can be seen, adhesion is poor. Although it would be expected that the addition of wax should improve adhesion, this sample illustrates that this is not the case. In the present invention, it is the polymer that is providing the improved adhesive benefits, not the addition of wax to the sample.

TABLE 1

| | C1 | C2 | 1 | 2 | 3 | 4 |
|---|---|---|---|---|---|---|
| IRGANOX 1010 | 0.5 | 0 | 0 | 0.5 | 0.5 | 0.5 |
| BHT | 0 | 0.8 | 0.8 | 0 | 0 | 0 |
| PARAFLINT H4 | 20 | 0 | 0 | 0 | 0 | 0 |
| PARAFLINT H1001 | 0 | 0 | 20 | 20 | 20 | 20 |
| AT 191A | 0 | 70 | 50 | 0 | 0 | 0 |
| ELVAX 420 | 40 | 0 | 0 | 0 | 0 | 0 |
| ELVAX 460 | 10 | 0 | 0 | 0 | 0 | 0 |
| NIREZ 2040HM | 30 | 0 | 0 | 0 | 0 | 0 |
| EASTOTAC H130 | 0 | 30 | 30 | 30 | 30 | 40 |
| Copolymer A | 0 | 0 | 0 | 50 | 0 | 0 |
| Copolymer B | 0 | 0 | 0 | 0 | 50 | 0 |
| Copolymer C | 0 | 0 | 0 | 0 | 0 | 40 |
| Visc 350° F. | 11000 | 17700 | 5025 | 12150 | 11763 | 14050 |
| Blocking on Kraft | No Tack | Sl. Tack | Sl. Tack | V. Sl. Tack | No Tack | Sl. Tack |
| Corrugated | | | | | | |
| Blocking on UV Bag | Mod Tack | V. Sl. Tack | No Tack | V. Sl. Tack | Sl. Tack | Mod Tack |
| Ink Lift UV Bag | Mod. Lift | No Lift | No Lift | No Lift | Sl. Lift | V. Sl. Lift |
| Adhesion to FX845 | | | | | | |
| RT | 100, 75 | 75 | 0 | 90 | 100 | 80 |
| 40° F. | 100, 80 | 85, 50 | 0 | 75, 50 | 100 | 100 |
| 20° F. | 75, 25 | 25, 0 | 0 | 75, 50 | 100 | 85, 50 |
| 0° F. | 75, 50 | 0 | 0 | 50 | 100 | 100 |
| Adhesion to FC807 | | | | | | |
| RT | 80 | 25, 0 | 0 | 50 | 100 | 50 |
| 40° F. | 100, 85 | 50 | 0 | 75 | 100 | 100, 50 |
| 20° F. | 75 | 25, 10 | 0 | 75, 25 | 100 | 100, 85 |
| 0° F. | 50, 25 | 0 | 0 | 50 | 100, 85 | 100, 85 |

### Example 2

The reactivation of bag ending hot melts were measured with 99% fiber tear and 1.5 seconds set time at 15 psi. Coatings of 5 to 7 mil were preapplied to the bags. The results are shown below. All values are percent fiber tear.

TABLE 2

| | C1 | C2 | 1 | 2 | 3 | 4 |
|---|---|---|---|---|---|---|
| % Fiber | 99 | 99 | 99 | 99 | 99 | 99 |
| Tear | | | | | | |
| 170° F. | 0 | 0 | 0 | 0 | V. Sl. | 0 |
| 180° F. | 0 | Sl. | 0 | 0 | V. Sl. | 20 |
| 190° F. | 0 | Sl. | 0 | 5 | 25 | 50 |
| 200° F. | 0 | 15 | 0 | 25 | 35 | 50 |
| 210° F. | 10 | 35 | V. Sl. | 50 | 50 | 50 |
| 220° F. | 25 | 30 | 10 | 80 | 60 | 60 |
| 230° F. | 30 | 50 | 40 | 90 | 100 | 90 |
| 240° F. | 40 | 60 | 75 | 100 | 100 | 100 |
| 250° C. | 75 | 75 | 80 | 100 | 100 | 100 |
| 260° C. | 100 | 100 | 100 | 100 | 100 | 100 |
| 20 min between pull | | | | | | |

Products that have good non-block properties typically reactivate at higher temperatures. For example C2, the PE product, reactivates at 260° F. It is most desirable to have reactivation temperatures greater than 170° F., however as low as possible above that temperature. Surprisingly, Samples 2, 3 and 4 reactivate in the 230 to 240° F. range much lower than that of typical adhesives.

We claim:

1. A bag formed utilizing a hot melt adhesive composition, said adhesive composition comprising:
a) 20 to 70 parts ethylene/alpha olefin polymer;
b) 10 to 50 parts tackifier; and
c) 0 to 30 parts wax.

2. A bag according to claim 1 wherein the ethylene/alpha olefin polymer has a melt index of 10 to 500 MI, a melt point of 71 to 90° C., a density of 0.885 to 0.92, a composition distribution breadth index greater than 50%, and Mw/Mn less than 6.

3. A bag according to claim 1 wherein the ethylene/alpha olefin polymer has a melt index of 50 to 500 MI, a melt point of 71 to 90° C., a density of 0.885 to 0.90, a composition distribution breadth index greater than 50%, and Mw/Mn less than 6.

4. A bag according to claim 1 wherein the ethylene/alpha olefin polymer is an ethylene/butene copolymer.

5. A bag according to claim 1 wherein the ethylene/alpha olefin polymer is an ethylene/butene copolymer having a density of 0.901 and melt index of 125.

6. A bag according to claim 1 wherein the ethylene/alpha olefin polymer is an ethylene/butene copolymer having a density of 0.885 and melt index of 125.

7. A bag according to claim 1 wherein the ethylene/alpha olefin polymer is an ethylene/butene copolymer having a density of 0.885 and melt index of 50.

8. A hot melt adhesive composition comprising:
a) 20 to 70 parts ethylene/alpha olefin polymer;
b) 10 to 50 parts tackifier; and
c) 0 to 30 parts wax.

9. An adhesive according to claim 8 wherein the ethylene/alpha olefin polymer has a melt index of 10 to 500 MI, a melt point of 71 to 90° C., a density of 0.885 to 0.92, a composition distribution breadth index greater than 50%, and Mw/Mn less than 6.

10. An adhesive according to claim 8 wherein the ethylene/alpha olefin polymer has a melt index of 50 to 500 MI, a melt point of 71 to 90° C., a density of 0.885 to 0.90, a composition distribution breadth index greater than 50%, and Mw/Mn less than 6.

11. An adhesive according to claim 8 wherein the ethylene/alpha olefin polymer is a n ethylene/butene copolymer.

12. An adhesive according to 8 wherein the ethylene/alpha olefin polymer is an ethylene/butene copolymer having a density of 0.901 and melt index of 125.

13. An adhesive according to claim 8 wherein the ethylene/alpha olefin polymer is an ethylene/butene copolymer having a density of 0.885 and melt index of 125.

14. An adhesive according to claim 8 wherein the ethylene/alpha olefin polymer is an ethylene/butene copolymer having a density of 0.885 and melt index of 50.
